(19) United States
(12) Patent Application Publication
(10) Pub. No.: US 2015/0098239 A1
(43) Pub. Date: Apr. 9, 2015

(54) LIGHTING DEVICE WITH REMOTE DOWN-CONVERTING MATERIAL

(71) Applicant: 3M Innovative Properties Company, Saint Paul, MN (US)

(72) Inventors: Gilles Jean-Baptiste Benoit, Minneapolis, MN (US); Michael Francis Weber, Shoreview, MN (US); Catherine Anne Leatherdale, Woodbury, MN (US)

(73) Assignee: 3M Innovative Properties Company, Saint Paul, MN (US)

(21) Appl. No.: 14/047,743

(22) Filed: Oct. 7, 2013

(51) Int. Cl. F21K 99/00

(52) U.S. Cl. CPC F21K 9/56; F21K 9/52
USPC 362/555; 362/84

(57) ABSTRACT

A lighting device is disclosed with remote down-converting material and, in particular, a solid state lighting device that forms multiple virtual light sources on remote down-converting material. The lighting devices utilizes a free-form optic having two or more focal points that generates two or more images of the light sources are formed from a single LED light source. Down-converting material is located at the two or more images of the light source.

### FIELD

The disclosure relates to lighting devices with remote down-converting material and, in particular, to a solid state lighting device that forms multiple virtual light sources on remote down-converting material.

### BACKGROUND

Quasi point light sources such as light emitting diodes (i.e., LED), for example, are efficient light sources that are gaining popularity in many types of lighting. One challenge for these light sources is efficiently distributing the relatively concentrated light from the LED. Recent developments in LED technology are pushing LED flux and efficacy toward their theoretical limits, now exceeding 300 W/cm² and 150 lm/W commercially.

White or broadband light can be emitted from these light sources by combining a blue LED with a layer of yellow-emitting phosphor. As light from the blue LED passes through the phosphor layer, some of the blue light is absorbed, and a substantial portion of the absorbed energy is re-emitted by the phosphor as Stokes-shifted light at longer wavelengths in the visible spectrum, typically, yellow light so as to provide broadband output of light having a white appearance.

A significant amount of heat is generated by the LED both at the die level and phosphor level (Quantum yield losses, Stokes shift, reabsorption in the LED chip), especially as new die and packaging technology enable continuously increasing amounts of light generated per LED package following Haitz's law. This high thermal load not only reduces the efficiency of the white LED but it also shortens the life of the phosphor and encapsulant material.

One solution to this problem is to separate the phosphor material from the LED die. However, this solution increases the amount of phosphor required to homogeneously convert blue light into white light. This is due to the fact that the amount of phosphor increases with the area illuminated by the LED, which generally scales as the cube (for a sphere) or square (for a plane) of the distance to the LED. This translates to an unreasonable amount of phosphor (and associated cost) and; an increased light emission footprint.

### BRIEF SUMMARY

The disclosure relates to lighting devices with remote down-converting material and, in particular, to a solid-state lighting device that forms multiple virtual light sources on remote down-converting material. The lighting devices utilize a free-form optic that generates two or more virtual white light sources from a single short wavelength LED light source by forming two or more images of the LED on down-converting material at the two or more virtual light source locations.

In many embodiments, a lighting device includes a light source and a free-form reflector registered with the light source and receiving non-collimated light from the light source. The free-form reflector has two or more focal points where images of the light source are formed. Down-converting material is located at the two or more images of the light source.

In further embodiments, a lighting device includes a light source and a free-form reflector registered with the light source and receiving non-collimated light from the light source. The free-form reflector forms two or more images of the light source. An inhomogeneous down-converting surface intercepts the two or more images of the light source.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic diagram of an illustrative lighting device of the disclosure;

FIG. 2A-2C are schematic diagrams of illustrative down-converting surfaces illuminated by the image of the light source;

FIG. 3 is a schematic diagram of an illustrative lighting device package of the disclosure;

FIG. 4 is a schematic diagram of the cross-section of an illustrative lighting device of the disclosure that mimics an incandescent light;

FIG. 5 is a schematic diagram of the cross-section of an illustrative lighting device of the disclosure that mimics a fluorescent light;

FIG. 6 is a schematic diagram of an illustrative lighting device luminaire of the disclosure;

FIG. 7 is a schematic diagram top view of an illustrative lighting device of the disclosure that enables light tuning;

FIG. 8 is a light spectrum graph illustrating the light spectrum of 10 different locations along the in-homogenous ring of down-converting material when illuminated with white light;

FIG. 9 is an illustrative graph of blackbody color (CCT) as a function of phosphor fraction for the in-homogenous ring of down-converting material illustrated in FIG. 7 and FIG. 8;

FIG. 10 is a schematic diagrams of another illustrative down-converting surface illuminated by the image of the light source; and

FIG. 11 is a schematic diagrams of another illustrative light device of the disclosure that enables color and angular distribution tuning.

The schematic drawings presented herein are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

The phrase, “free-form optic” or “free-form reflector” refers to an optic or reflector shaped through computerized design to redistribute a given geometrical optics feed power pattern into a prescribed amplitude aperture distribution. This type of optic or reflector is also known as a non-imaging optic or an anamorphic reflector.

The disclosure relates to lighting devices with remote down-converting material and, in particular, to a solid-state lighting device that forms multiple virtual light sources on remote down-converting material. The lighting devices utilize a free-form optic that generates two or more virtual white light sources from a single short-wavelength LED light source by forming two or more images of the LED on down-converting material at the two or more virtual light source locations. The lighting device utilizes one or more free-form reflector(s) and highly efficient reflective material to efficiently direct and transport light from a point source to form multiple images of the point source a certain distance away from the point source. The lighting device can utilize one physical LED to create N virtual (imaged) LEDs whose individual brightness is on the order of 1/N that of the physical LED and whose footprint is comparable to that of the physical LED. This is useful because it enables the efficient conversion of a single high-brightness blue/UV LED into a multitude of ‘virtual’ high efficacy low/medium-brightness white LEDs. Like traditional remote phosphor implementations the spatial separation between the LED die and the heat-sensitive down-converting material delivers higher system efficiency and longer life-time. Unlike traditional remote phosphor implementations, the amount of down-converting material required is relatively small as it is only a function of N and the size of the physical LED and not of the distance between the LED die and the down-converting material. In addition, the virtual light sources generated maintain a small LED-like footprint. While the present disclosure is not so limited, an appreciation of various aspects of the disclosure will be gained through a discussion of the examples provided below.

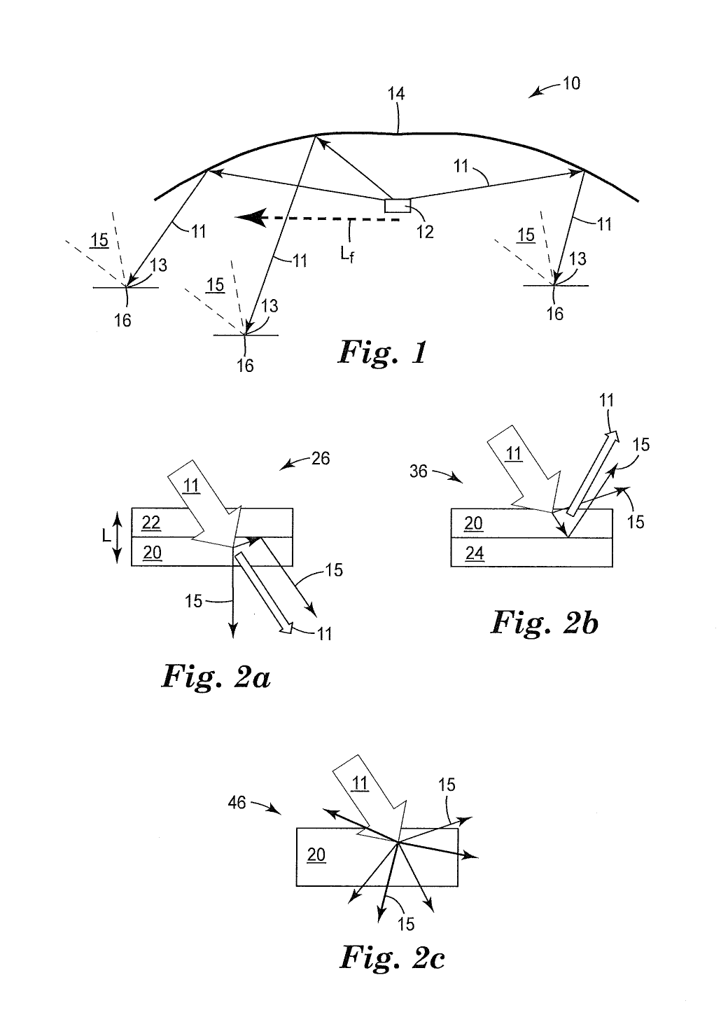

FIG. 1 is a schematic diagram of an illustrative lighting device 10 of the disclosure. The lighting device 10 includes a light source 12, a free-form reflector 14 registered with the light source 12 and receiving non-collimated light 11 from the light source 12. The free-form reflector 14 has two or more focal points where images 13 of the light source are formed. Down-converting material 16 is located at the two or more images 13 of the light source. The lighting device 10 can take any useful form such as a die, package, luminaire, display or light bulb.

The illustrated free-form reflector 14 forms three images 13 of the light source. It is understood that the free-form reflector 14 forms at least two images 13 of the light source but can form 4, 5, 6, 7, 8, 9, 10 or more images 13 of the light source, as desired. These images can overlap to form a spatially continuous light distribution. In some embodiments the images 13 of the light source are on a same plane. In other embodiments the images 13 of the light source are not on the same plane or are on different planes.

The light source 12 can be a solid-state light source. Solid state light sources include light emitting diodes (LEDs). The term “light emitting diode” or “LED” refers to a diode that emits light, whether visible, ultraviolet, or infrared. In many embodiments the LED emits UV or blue light or both UV and blue light. In many practical embodiments the emitted light will have a peak wavelength in a range from about 430 to 530 nm, or from about 440 to 500 nm, or from about 440 to 460 nm. The term LED includes incoherent encased or encapsulated semiconductor devices marketed as “LEDs”, whether of the conventional or super radiant variety, as well as coherent semiconductor devices such as laser diodes, including but not limited to vertical cavity surface emitting lasers (VCSELs). An LED can consist of a single or a cluster of LED die(s). An “LED die” is an LED in its most basic form, i.e., in the form of an individual component or chip made by semiconductor processing procedures. For example, the LED die may be formed from a combination of one or more Group III elements and of one or more Group V elements (III-V semiconductor). Examples of suitable III-V semiconductor materials include nitrides, such as gallium nitride, and phosphides, such as indium gallium phosphide. Other types of III-V materials can also be used, as well as inorganic materials from other groups of the periodic table. The component or chip can include electrical contacts suitable for application of power to energize the device. Examples include wire bonding, tape automated bonding (TAB), or flip-chip bonding. The individual layers and other functional elements of the component or chip are typically formed on the wafer scale, and the finished wafer can then be diced into individual piece parts to yield a multiplicity of LED dies. The LED die may be configured for surface mount, chip-on-board, or other known mounting configurations. Some packaged LEDs are made by forming a polymer encapsulant over an LED die and an associated reflector cup. The LED may be grown on one of several substrates. For example, GaN LEDs may be grown by epitaxy on sapphire, silicon, and gallium nitride. An “LED” for purposes of this application should also be considered to include organic light emitting diodes, commonly referred to as OLEDs and quantum dot light emitting diodes, commonly referred to as QLEDs.

In some embodiments the free-form reflector 14 reflects substantially all of the light 11 emitted by the light source 12. In these embodiments the reflective surfaces of the free-form reflector 14 can be formed of a highly reflective material, such as at least about 95% efficient or at least about 98% efficient or at least about 99% efficient for light incident at any angle on the free-form reflector 14.

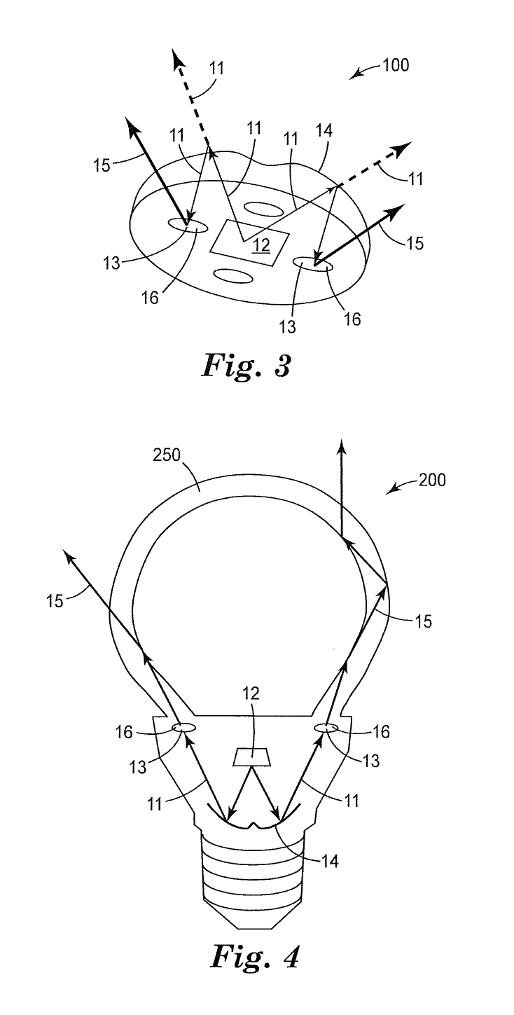

In other embodiments the free-form reflector 14 is a partial reflector for the wavelengths of light emitted by the light source 12. In these embodiments the reflective surfaces of the free-form reflector 14 can be formed of a band pass reflective material reflecting at least about 50% or in a range from about 50% to 90% of light emitted by the light source 12 and transmitting at least about 50% or at least about 80% or at least 90% or at least 95% of light emitted by the down converting material 16 for light incident at any angle on the free-form reflector 14 (see e.g., FIG. 3).

Illustrative reflective multilayer polymeric film useful for forming the free-form reflector is described in U.S. Pat. No. 6,788,463 and is incorporated by reference herein. These reflective multilayer polymeric films are thermoformable and can be utilized to create the complex reflective curvatures that form the free-form optic reflectors. The free-form reflector may have primarily specular reflectivity. The specular reflectivity in general is greater than 50% of the total reflective coefficient. Other materials could also be used such as vacuum deposited thin metal films (for example silver) on polymeric substrates.

The free-form reflector is large enough to capture or redirect a majority of the non-collimated light (Lambertian or isotropic emission) emitted by the light source. In many embodiments the free-form reflector has a minimum focal length L_{f} and a minimum focal parameter that is at least 5 times the length or width (whichever is larger) forming the light emission surface area of the light source. As described above, the minimum focal length is the minimum distance between the two foci of any conic subsection of the reflector while the minimum focal parameter is the minimum distance from the focus (source center position) to the conic section directix of any conic subsection of the reflector. One free-form reflector usually has multiple focal lengths and focal parameters. The shape of the free-form reflector to achieve a prescribed amplitude aperture distribution can be calculated using algorithms known in the art such as those demonstrated by Prof. Vladimir Oliker in December 2001 (“A Rigorous Method for Synthesis of Offset Shaped Reflector Antennas”, Journal of Computational Methods in Sciences and Engineering) and published in 2006.

Down-converting material 16 can be any useful material that emits light of a longer wavelength than the light incident on the down-converting material. In many embodiments the down-converting material is a phosphor material or a combination of phosphor materials. The phosphor material absorbs some or all of the incident light 11, and re-emits some of the absorbed energy as Stokes shifted (longer wavelength) down-converted light 15. The down-converted light 15 can be emitted by the phosphor material in all directions, and such light can be narrow band (e.g. spectral width less than 40 nanometers) or broadband (e.g. spectral width of at least 100 nanometers broadband).

The down-converting material 16 can contains one or more suitable phosphor materials that fluoresce or otherwise emit light that is Stokes shifted relative to the absorbed light. In many embodiments, the phosphor material absorbs light in a range that overlaps in wavelength with the emission spectrum of the light source, such that the light source light can excite the phosphor and cause it to fluoresce or otherwise emit phosphor light. In many cases, a given phosphor material may absorb light in the ultraviolet, blue, and/or blue-green portion of the electromagnetic spectrum, and may emit light in the visible or near-visible region. The emitted phosphor light is typically broadband, e.g., it may have a spectral width of at least 100 nanometers. The broadband phosphor light may be distributed in a continuous broad band, or it may have a spiked distribution as in the case of a collection of spaced-apart narrow emission lines, or it may be a combination of narrow emission lines and a continuous broad band. Exemplary phosphor materials include known fluorescent dyes and phosphors. Cerium-doped yttrium aluminum garnet (Ce:YAG) is one example of a phosphor that may be used. Other rare-earth doped garnets or other rare-earth doped materials may also be suitable, e.g., europium- and/or strontium-doped silicates, nitrides, and aluminates, depending on design details and constraints of the light source. Suitable phosphor materials may include organic and inorganic fluorescent or phosphorescent materials, such as doped inorganic oxides or nitrides, quantum dots, and semiconductors including II-VI and III-V materials.

FIG. 2A-2C are schematic diagrams of illustrative down-converting surfaces 26, 36, 46 illuminated by the image of the light source 12. The down-converting surface can contain as few as one layer as illustrated in FIG. 2c. In this embodiment, the down-converting surface 46 includes a single down-converting material layer such as a phosphor layer 20, the material of which is described above. The down-converting material layer may consist of a dispersion of phosphor material in a polymer matrix. It may additionally contain a dispersion of scattering elements (e.g. voids, TiO2 particles, glass or polymer beads) to reduce the down-converting material concentration and improve angular color uniformity. The layer may also have appropriate water and oxygen barrier properties for reactive down-converting materials like quantum dots.

In another embodiment the down-converting surface can contain at least two layers as illustrated in FIG. 2b. In this embodiment, the down-converting surface 36 includes a down-converting material layer such as a phosphor layer 20 and a highly reflective layer 24. The highly reflective layer 24 can reflect both the light 11 emitted from the light source and light 15 emitted by the down-converting material layer. The highly reflective layer 24 can be formed of a highly reflective material, such as at least about 95% efficient or at least about 98% efficient or at least about 99% efficient for light incident at any angle on the highly reflective layer 24. Suitable highly reflective layer 24 with predominantly specular characteristics include multilayer optical films configured for high reflectivity across the visible spectrum, such as Vikuiti™ Enhanced Specular Reflector Film (ESR) marketed by 3M Company, which has greater than 98% reflectivity over the visible region. Other dielectric coating reflectors, made from optically thin layers of high and low index materials, such as nanovoided polymers or other polymers, MgF₂, TiO₂, SiO₂, Al₂O₃, and/or ZrO₂, may also be used. Simpler metal-coated films, such as aluminum-coated polymer films or silver-coated polymer films, may also be used. The reflectivity of a metal coating may be enhanced by, for example, adding one or more known dielectric coatings such as nanovoided polymers or other polymers, inorganic nanoparticulate filled polymers, MgF₂, TiO₂, SiO₂, Al₂O₃, and/or ZrO₂. Suitable highly reflective layer 24 with predominantly diffuse characteristics include micro-voided PET (MCPET). Layer 24 may also include an ultra-low index (ULI) coating positioned adjacent to phosphor layer 20. Layer 20 and layer 24 may be in optical contact or separated by a small air gap.

In another embodiment the down-converting surface can contain at least two layers as illustrated in FIG. 2a. In this embodiment, the down-converting surface 26 includes a down-converting material layer such as a phosphor layer 20 and a band-pass reflective layer 22. The band-pass reflective layer 22 reflects light 15 emitted by the down-converting material layer and transmits light 11 emitted by the light source.

The band-pass reflective layer 22 is designed to have a high reflectivity and low transmission for some optical wavelengths, and a low reflectivity and high transmission for other optical wavelengths. Such band-pass reflectors ordinarily have negligible absorption, such that any light that is not reflected is substantially transmitted, and vice versa, at least over visible, near infrared, and near-ultraviolet wavelengths. Such band-pass reflectors include stacks of optically thin microlayers, typically in an alternating arrangement of materials having a large refractive index mismatch, such as alternating layers of silicon dioxide and titanium dioxide, but other suitable inorganic or organic materials may also be used. Such band-pass reflectors may be made by vacuum deposition of the alternating layers on a glass or other suitable substrate, e.g., directly on the outer surface of a lens member, or on a film or substrate that can be subsequently applied to such a surface. Alternatively, suitable band-pass reflective films may be made by a continuous process that may involve coextrusion of alternating polymer materials and stretching the resulting multilayer polymer web, e.g. as described in U.S. Pat. Nos. 5,882,774 and 6,783,349. Regardless of the materials used in the band-pass reflector and the method of manufacture used, the band-pass reflector is provided with a layer thickness profile for the stack of microlayers that is tailored to provide the desired reflection characteristics as a function of wavelength, as described herein. Layer 22 may also include an ultra-low index (ULI) coating positioned adjacent to phosphor layer 20. Layer 20 and layer 22 may be in optical contact or separated by a small air gap.

In one embodiment the down-converting surface 26 includes a pass-band reflector layer 22 that transmits blue light 11 from the light source 12 and reflects light 15 emitted from the down-converting material 20 and the pass-band reflector layer 22 is located between the light source 12 and the down-converting material 20. This is illustrated by combining FIG. 1 and FIG. 2a.

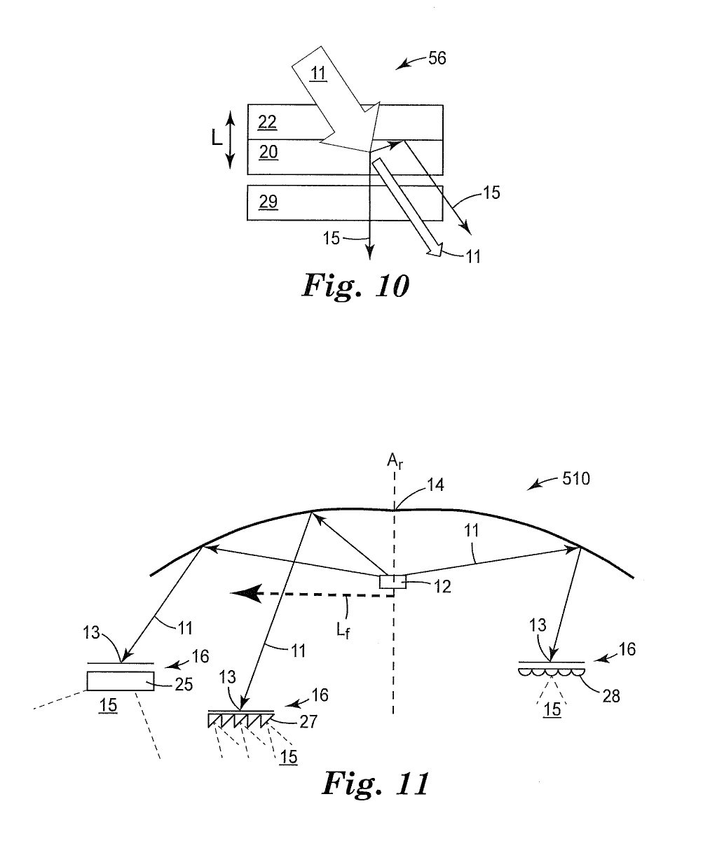

In another embodiment the down-converting surface can contain at least three layers as illustrated in FIG. 10. In this embodiment, the down-converting surface 56 includes a down-converting material layer such as a phosphor layer 20 between a band-pass reflective layer 22 (described above) and a light redirecting layer 29. The band-pass reflective layer 22 reflects light 15 emitted by the down-converting material layer and transmits light 11 emitted by the light source. The light redirecting layer 29 can redirect both light 11 emitted from the light source 12 and light 15 emitted by the down-converting material. The light redirecting layer 29 can be a scattering layer to provide more angularly uniform color distribution and brightness uniformity. Layer 25 can be a refractive layer (e.g. prismatic, micro-lens) designed to control the angular distribution of the emitted light.

FIG. 3 is a schematic diagram of an illustrative lighting device package 100 of the disclosure. The lighting device package 100 provides a compact design and includes a light source 12, a free-form reflector 14 registered with the light source 12 and receiving non-collimated light 11 from the light source 12. The free-form reflector 14 has two or more focal points where images 13 of the light source are formed. Down-converting material 16 is located at the two or more images 13 of the light source.

The illustrated lighting device package 100 free-form reflector 14 forms four images 13 of the light source. It is understood that the free-form reflector 14 forms at least two images 13 of the light source but can also form 5, 6, 7, 8, 9, 10 or more images 13 of the light source, as desired. As illustrated, the images 13 of the light source are on a same plane. In other embodiments the images 13 of the light source are not on the same plane or are on different planes.

In this embodiment, the free-form reflector 14 is disposed over both the light source 12 and the down-converting material 16. The free-form reflector 14 can enclose both the light source 12 and the down-converting material 16. The light source 12 and the down-converting material 16 can be co-planar or disposed on the same plane, as illustrated. The down-converting material 16 can be disposed on any of down-converting surfaces described herein. For example, the down-converting surface can be illustrated by FIG. 2b, described above.

In this embodiment the free-form reflector 14 is a partial reflector for the wavelengths of light 11 emitted by the light source 12. In this embodiment the reflective surfaces of the free-form reflector 14 can be formed of a band pass reflective material reflecting at least about 50% or in a range from about 50% to 90% of light emitted by the light source 12 and transmitting at least about 50% or at least about 80% or at least 90% or at least 95% of light emitted by the down converting material 16 for light incident at any angle on the free-form reflector 14. The band pass reflective material forming the free-form reflector 14 can be tailored to transmit more or less light 11 emitted by the light source 12 in order to modify the overall color emitted from the illustrated lighting device package 100.

FIG. 4 is a schematic diagram of an illustrative lighting device 200 of the disclosure that mimics an incandescent light. The lighting device 200 includes a light source 12, a free-form reflector 14 registered with the light source 12 and receiving non-collimated light 11 from the light source 12. The free-form reflector 14 has two or more focal points where images 13 of the light source are formed. Down-converting material 16 is located at the two or more images 13 of the light source. The down-converting material 16 can be disposed on any of down-converting surfaces described herein. For example, the down-converting surface can be illustrated by FIG. 2a, described above. A light guide 250 is arranged and configured to receive the light emitted or transmitted by the down-converting material 16 and direct this light as desired. In the illustrated embodiment, the light guide 250 transmits light to mimic a conventional light bulb.

The illustrated lighting device 200 free-form reflector 14 forms two images 13 of the light source. It is understood that the free-form reflector 14 forms at least two images 13 of the light source but can also form 3, 4, 5, 6, 7, 8, 9, 10 or more images 13 of the light source, as desired. The free-form reflector 14 can also form an infinite number of overlapping images 13 of the light source that together form a continuous ring of light. As illustrated, the images 13 of the light source are on a same plane. In other embodiments the images 13 of the light source are not on the same plane or are on different planes.

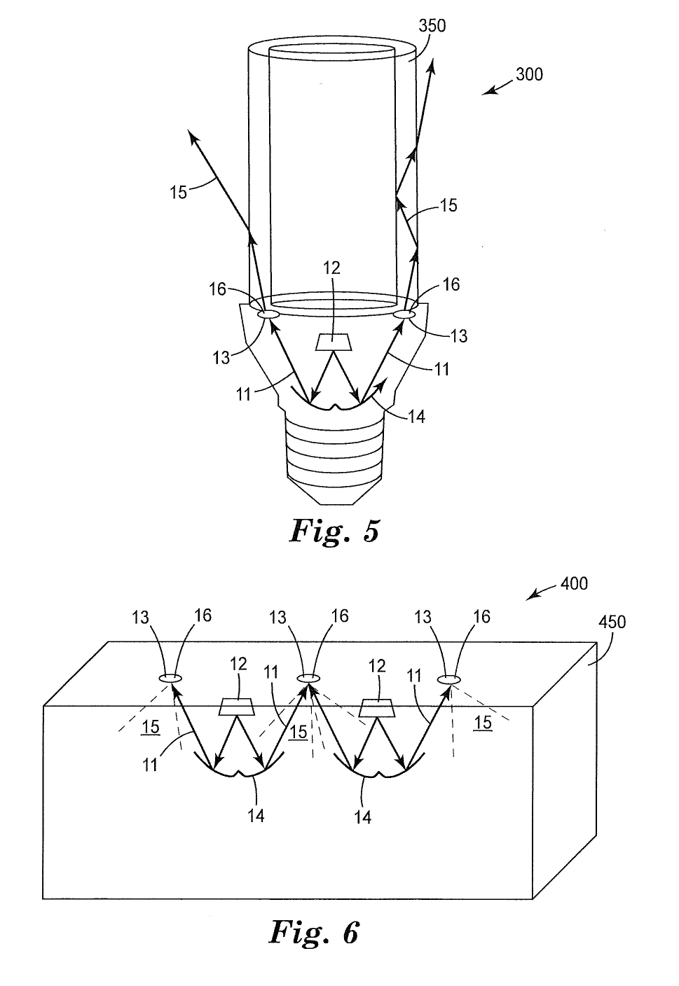

FIG. 5 is a schematic diagram of an illustrative lighting device 300 of the disclosure that mimics a fluorescent tube light. The lighting device 300 includes a light source 12, a free-form reflector 14 registered with the light source 12 and receiving non-collimated light 11 from the light source 12. The free-form reflector 14 has two or more focal points where images 13 of the light source are formed. Down-converting material 16 is located at the two or more images 13 of the light source. The down-converting material 16 can be disposed on any of down-converting surfaces described herein. For example, the down-converting surface can be illustrated by FIG. 2a, described above. A light guide 350 is arranged and configured to receive the light emitted or transmitted by the down-converting material 16 and direct this light as desired. In the illustrated embodiment, the light guide 350 transmits light to mimic a conventional fluorescent light bulb.

The illustrated lighting device 300 free-form reflector 14 forms two images 13 of the light source. It is understood that the free-form reflector 14 forms at least two images 13 of the light source but can also form 3, 4, 5, 6, 7, 8, 9, 10 or more images 13 of the light source, as desired. The free-form reflector 14 can also form an infinite number of overlapping images 13 of the light source that together form a continuous ring of light. As illustrated, the images 13 of the light source are on a same plane. In other embodiments the images 13 of the light source are not on the same plane or are on different planes.

FIG. 6 is a schematic diagram of an illustrative lighting device luminaire 400 of the disclosure. The lighting device luminaire 400 includes a plurality of light sources 12, a free-form reflector 14 registered with each light source 12 and receiving non-collimated light 11 from the light source 12. The free-form reflector 14 has two or more focal points where images 13 of the light source are formed. Down-converting material 16 is located at the two or more images 13 of the light source. A light guide 450 is arranged and configured to receive the light emitted or transmitted by the down-converting material 16 and direct this light as desired. In the illustrated embodiment, the light guide 450 is a hollow light guide that transmits light through one or more of its surfaces to mimic a conventional light fixture. The light emitted or transmitted by the down-converting material 16 is illustrated as being emitted into the light guide 450, in other embodiments light emitted or transmitted by the down-converting material 16 is emitted out from light guide 450.

The illustrated lighting device 400 each free-form reflector 14 forms two images 13 of the light source. It is understood that each free-form reflector 14 forms at least two images 13 of the light source but can also form 3, 4, 5, 6, 7, 8, 9, 10 or more images 13 of the light source, as desired. The free-form reflectors 14 can also form an infinite number of overlapping images 13 of the light source that together form a continuous plane of light. As illustrated, the images 13 of the light source are on a same plane. In other embodiments the images 13 of the light source are not on the same plane or are on different planes.

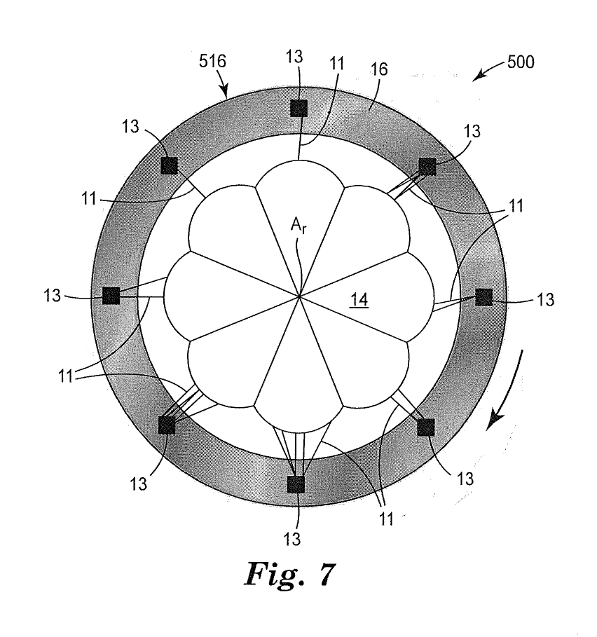

FIG. 7 is a schematic diagram top view of an illustrative light tuning lighting device 500 of the disclosure. The lighting device 500 includes a light source (hidden beneath the free-form reflector), a free-form reflector 14 registered with the light source and receiving non-collimated light from the light source. The free-form reflector 14 has two or more focal points where images 13 of the light source are formed. Down-converting material 16 is located at the two or more images 13 of the light source. The illustrated lighting device 500 free-form reflector 14 forms 8 images 13 of the light source. It is understood that the free-form reflector 14 forms at least two images 13 of the light source but can also form 3, 4, 5, 6, 7, 9, 10 or more images 13 of the light source, as desired. As illustrated, the images 13 of the light source are on a same plane. In other embodiments the images 13 of the light source are not on the same plane or are on different planes.

In many embodiments the inhomogeneous down-converting surface 516 surrounds the light source. In many embodiments the free-form reflector 14 and the inhomogeneous down-converting surface 516 are disposed on an axis of rotation Aᵣ and rotate relative to each other. For example, in one embodiment the free-form reflector 14 is fixed and the inhomogeneous down-converting surface 516 rotates about the free-form reflector 14. In another embodiment, the inhomogeneous down-converting surface 516 is fixed and the free-form reflector 14 rotates about the inhomogeneous down-converting surface 516.

This lighting device 500 includes an inhomogeneous down-converting surface 516 intercepts the two or more images 13 of the light source. The phrase ‘inhomogeneous down-converting surface’ refers to a surface of down-converting material that changes its composition or concentration of down-converting material and the light emitted from the down-converting material changes as a function of the position along the inhomogeneous down-converting surface. A regular pattern of down-converting material can be disposed between each images 13 of the light source so that the light spectrum of the emitted light can be altered by rotating the free-form reflector 14 relative to the inhomogeneous down-converting surface. As illustrated, the 8 images 13 of the light source form a pattern having 8-fold symmetry and the pattern of down-converting material can have (m times 8)-fold symmetry, where m is an integer greater or equal to 1.

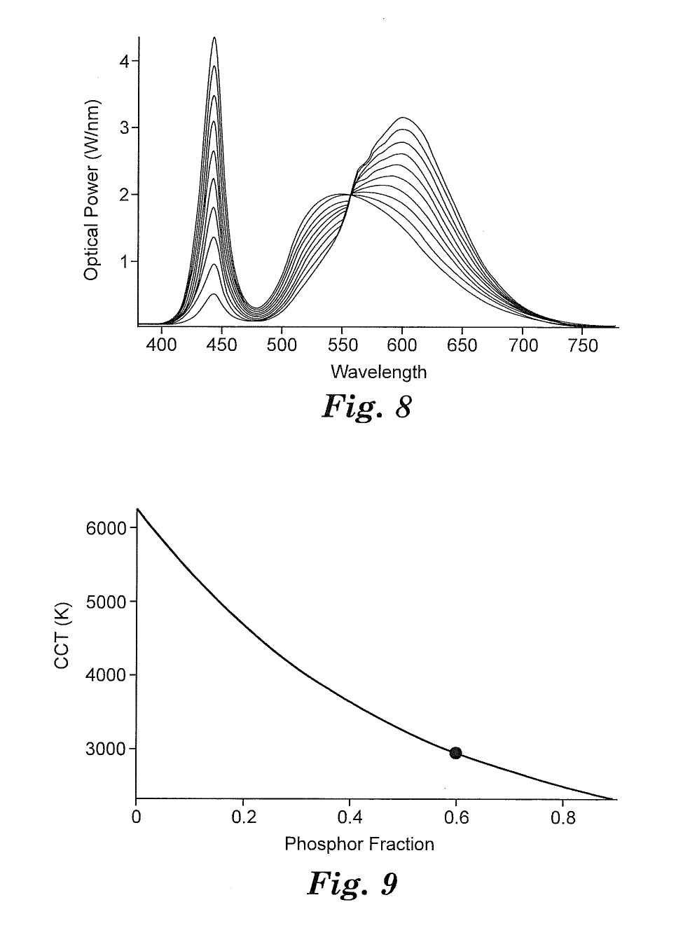

FIG. 8 is a light spectrum graph illustrating the light spectrum of 10 different locations along the in-homogenous ring of down-converting material when illuminated with a white LED. These 10 different locations can all separate each image 13 of the light source to provide a regular pattern between each image 13 of the light source and emit a regular spectrum pattern. This in-homogeneous down-converting surface can be formed by changing the phosphor fraction along the length of the in-homogeneous down-converting surface. In some embodiments, the inhomogeneous down-converting surface 516 is an annular ring of down-converting material that emits light having a different color temperature as a function of a location around the annular ring of down-converting material.

In some embodiments the emitted light color temperature varies from about 1500K (sunrise/sunset) to about 7000K (noon) as a function of a location on in-homogeneous down-converting surface. This rotation can be manually, mechanically, or electronically controlled. In one illustrative embodiment, the emitted light color temperature varies as a function of a time of day following the circadian rhythm. This can be accomplished, for example, with a control circuit that mechanically or electronically rotates the free-form reflector 14 relative to the inhomogeneous down-converting surface 516 and emits a color temperature that varies as a function of a time of day following the circadian rhythm.

FIG. 9 is an illustrative graph of blackbody color (CCT) as a function of phosphor fraction for the in-homogenous ring of down-converting material illustrated in FIG. 7 and FIG. 8. This graphs are based on one exemplary phosphor material described in U.S. Pat. No. 7,112,921 as known under the trade designation of BUVRO2 from PhosphorTech Corporation (3645 Kennesaw North Industrial Parkway•Kennesaw, Ga. 30144).

Light emitted from the in-homogeneous down-converting surface can be coupled to a light guide and utilized as described herein. In some embodiments, a reflector layer is disposed between the light source and the inhomogeneous down-converting surface and the reflector layer transmits blue light and reflects light emitted from the inhomogeneous down-converting surface, as described above. In other embodiments, the inhomogeneous down-converting surface is disposed on a broadband reflector layer that reflects at least 95% of visible light, as described above.

FIG. 11 is a schematic diagram of another illustrative light tuning light device 510 of the disclosure. The light tuning light device 510 includes a light source 12, a free-form reflector 14 registered with the light source 12 and receiving non-collimated light 11 from the light source 12. The free-form reflector 14 has two or more focal points where images 13 of the light source are formed. Down-converting material 16 is located at the two or more images 13 of the light source. The light tuning light device 510 can take any useful form such as a die, package, luminaire, display or light bulb.

The illustrated free-form reflector 14 forms three images 13 of the light source. It is understood that the free-form reflector 14 forms at least two images 13 of the light source but can form 4, 5, 6, 7, 8, 9, 10 or more images 13 of the light source, as desired. In some embodiments the images 13 of the light source are on a same plane. In other embodiments the images 13 of the light source are not on the same plane or are on different planes.

In many embodiments this can be a similar construction as illustrated in FIG. 7 and include a ring of optics that emits light having a different angular distribution as a function of a location around the ring of optics. The angular distribution of the emitted light can be altered by utilizing different optics along the length of the ring of optics. In some embodiments the down-converting material is uniformly disposed along the ring of optics, in other embodiments the down-converting material is in-homogenously disposed along the ring of optics.

This ring of altering optics can include a diffuser 25, prisms 27, microlens 28, and the like. In many embodiments the free-form reflector 14 and the ring of optics are disposed on an axis of rotation Aᵣ and rotate relative to each other. For example, in one embodiment the free-form reflector 14 is fixed and the ring of optics rotates about the free-form reflector 14. In another embodiment, the ring of optics is fixed and the free-form reflector 14 rotates about the ring of optics. A regular pattern of optics can be disposed between each images 13 of the light source so that the angular distribution of the emitted light can be altered by rotating the free-form reflector 14 relative to the ring of optics. This rotation can be manually, mechanically or electronically controlled.

Thus, embodiments of LIGHTING DEVICE WITH REMOTE DOWN-CONVERTING MATERIAL are disclosed. One skilled in the art will appreciate that the optical films and film articles described herein can be practiced with embodiments other than those disclosed. The disclosed embodiments are presented for purposes of illustration and not limitation.

What is claimed is:

1. A lighting device, comprising:
a light source;
a free-form reflector registered with the light source and receiving non-collimated light from the light source, the free-form reflector having two or more focal points where images of the light source are formed;
down-converting material located at the two or more images of the light source.

2. The lighting device of claim 1, wherein the light source is a solid-state light source.

3. The lighting device of claim 1, wherein the free-form reflector reflects at least 95% of incident light.

4. The lighting device of claim 1, wherein the free-form reflector forms four or more images of the light source.

5. The lighting device of claim 1, wherein the free-form reflector is a partial reflector for the wavelengths emitted by the source (R>50%) and highly transmissive for wavelengths emitted by the down-converting material (T>50%).

6. The lighting device of claim 1, wherein a pass-band reflector layer, located between the light source and the down-converting material, transmits wavelengths emitted by the source and reflects wavelengths emitted from the down-converting material.

7. The lighting device of claim 1, wherein the down-converting material is disposed on a broadband reflector layer that reflects at least 95% of visible light.

8. The lighting device of claim 1, further comprising a diffusing layer configured to scatter both light emitted from the light source and light emitted by the down-converting material.

9. The lighting device of claim 1, further comprising a light guide arranged and configured to receive white light emitted by the down-converting material.

10. A lighting device, comprising:
a light source;
a free-form reflector registered with the light source and receiving non-collimated light from the light source, the free-form reflector forming two or more images of the light source;
an inhomogeneous down-converting surface that intercepts the two or more images of the light source.

11. The lighting device of claim 10, wherein the inhomogeneous down-converting surface surrounds the light source.

12. The lighting device of claim 10, wherein the free-form reflector and the inhomogeneous down-converting surface are disposed on an axis of rotation and rotate relative to each other.

13. The lighting device of claim 10, wherein the inhomogeneous down-converting surface is an annular ring of down-converting material that emits light having a different color temperature as a function of a location around the annular ring of down-converting material.

14. The lighting device of claim 13, wherein the emitted light color temperature varies from 1500K to 7000K as a function of a location on inhomogeneous down-converting surface.

15. The lighting device of claim 13, wherein the emitted light color temperature varies as a function of time of day following the circadian rhythm.

16. The lighting device of claim 10, wherein the free-form reflector forms four or more images of the light source.

17. The lighting device of claim 10, further comprising a light guide arranged and configured to receive light emitted from the inhomogeneous down-converting surface.

18. The lighting device of claim 10, wherein a reflector layer is disposed between the light source and the inhomogeneous down-converting surface and the reflector layer transmits the wavelengths emitted by the source and reflects the wavelengths emitted by the down-converting material.

19. The lighting device of claim 10, wherein the inhomogeneous down-converting surface is disposed on a broadband reflector layer that reflects at least 95% of visible light.

20. The lighting device of claim 10, further comprising a diffusing layer configured to scatter light emitted from the light source and the inhomogeneous down-converting surface.

21. The lighting device of claim 10, wherein the inhomogeneous down-converting surface is an annular ring of down-converting material that emits light having a different angular distribution as a function of a location around the annular ring of down-converting material.
